(19) United States
(12) Patent Application Publication
(10) Pub. No.: US 2016/0299915 A1
(43) Pub. Date: Oct. 13, 2016

(54) Retrieval Method And Retrieval Apparatus Based On Browser

(71) Applicant: TENCENT TECHNOLOGY (SHENZHEN) COMPANY LIMITED, Shenzhen (CN)

(72) Inventors: Feng JIANG, Shenzhen (CN); Kaixiang ZHANG, Shenzhen (CN); Baiyu QIU, Shenzhen (CN)

(21) Appl. No.: 15/189,542

(22) Filed: Jun. 22, 2016

Related U.S. Application Data
(63) Continuation of application No. PCT/CN2015/076862, filed on Apr. 17, 2015.

(30) Foreign Application Priority Data
Apr. 18, 2014 (CN) 201410156428.5

(51) Int. Cl. G06F 17/30; H04L 29/08

(52) U.S. Cl. CPC G06F 17/30117; G06F 17/3064; G06F 17/30312; G06F 17/30303; H04L 67/26; H04L 67/02

(57) ABSTRACT

A retrieval method includes acquiring, by a retrieval server, a search term on a retrieval page of the browser; searching for, by the retrieval server, associative term lists corresponding to the search term in a storage database; searching for, by the retrieval server, matching pages corresponding to the associative terms in the storage database, and sending the associative terms and the matching pages to the browser. The method further includes displaying, by the browser, the associative terms on the retrieval page; and receiving, by the browser, a selection instruction, and pushing the matching pages according to the selection instruction.

### CROSS-REFERENCE TO RELATED APPLICATIONS

This application is a continuation of International Application No. PCT/CN2015/076862, filed on Apr. 17, 2015. This application claims the benefit and priority of Chinese Application No. 201410156428.5, filed on Apr. 18, 2014. The entire disclosures of each of the above applications are incorporated herein by reference.

### FIELD

The present disclosure relates to Internet and to retrieval based on a browser.

### BACKGROUND

This section provides background information related to the present disclosure which is not necessarily prior art.

Search engines are widely used to search for a desired webpage, video, and audio information when surfing the Internet.

In the existing technology, a cloud retrieval server has an associative expansion function that associatively extends a search term input by a user and displays corresponding associative terms on a retrieval page of a browser in a manner of a drop-down list through the browser to facilitate the next search of the user.

After a search term is input in a search box of the retrieval page using the associative expansion function provided in the existing technology, the retrieval server will automatically request a Web service to acquire from another server associative terms related to the search term, which requires longer retrieval time, Therefore, the retrieval feedback speed and the retrieval efficiency of the user are low.

### SUMMARY

This section provides a general summary of the disclosure, and is not a comprehensive disclosure of its full scope or all of its features.

Various embodiments of the present disclosure provide a high-speed and efficient retrieval method based on a browser, so as to solve the technical issues of low retrieval feedback speed and retrieval efficiency in the existing retrieval methods.

Various embodiments of the present disclosure further provide a high-speed and efficient retrieval apparatus based on a browser, so as to solve the technical issues of low retrieval feedback speed and retrieval efficiency in the existing retrieval apparatuses.

To address the issues, the technical method provided in the present disclosure is as follows.

A retrieval method based on a browser is provided, the method includes:

acquiring, by a retrieval server, a search term on a retrieval page of the browser;

searching for, by the retrieval server, associative term lists corresponding to the search term in a storage database, the associative term lists including a plurality of associative terms;

searching for, by the retrieval server, matching pages corresponding to the associative terms in the storage database, and sending the associative terms and the matching pages to the browser;

displaying, by the browser, the associative terms on the retrieval page; and

receiving, by the browser, a selection instruction, and pushing the matching pages corresponding to the associative terms according to the selection instruction.

Various embodiments of the present disclosure further provide a retrieval apparatus based on a browser, the apparatus including:

a retrieval server, including:

a search term acquisition module, configured to acquire a search term on a retrieval page of the browser;

a storage database;

an associative term list search module, configured to search for associative term lists corresponding to the search term in the storage database, the associative term lists including a plurality of associative terms;

a matching page search module, configured to search for matching pages corresponding to the associative terms in the storage database; and

a sending module, configured to send the associative terms and the matching pages to the browser; and

the browser, including:

an associative term display module, configured to display the associative terms on the retrieval page; and

a pushing module, configured to receive a selection instruction, and push the matching pages corresponding to the associative terms according to the selection instruction.

Compared with the existing retrieval methods and retrieval apparatuses, the retrieval method and the retrieval apparatus based on a browser in the present disclosure can directly acquire corresponding retrieval data from a storage database, thereby shortening retrieval time of the retrieval server, improving retrieval efficiency of users, and solving the technical issues of low retrieval feedback speed and low retrieval efficiency in the retrieval methods and retrieval apparatuses of the existing technology.

Further areas of applicability will become apparent from the description provided herein. The description and examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a block diagram of a working environment of an electronic device of a retrieval apparatus based on a browser according to various embodiments of the present disclosure;

FIG. 2 is a block diagram of various embodiments of the retrieval apparatus based on a browser according to the present disclosure;

FIG. 3 is a flowchart of various embodiments of a retrieval method based on a browser according to the present disclosure;

FIG. 4 is a block diagram of various embodiments of the retrieval apparatus based on a browser according to the present disclosure;

FIG. 5 is a flowchart of various embodiments of the retrieval method based on a browser according to the present disclosure; and

FIG. 6 depicts a page for a retrieval method and a retrieval apparatus based on a browser according to the present disclosure.

Corresponding reference numerals indicate corresponding parts throughout the several views of the drawings.

### DETAILED DESCRIPTION

Example embodiments will now be described more fully with reference to the accompanying drawings.

Please refer to the drawings, wherein the same component symbols represent the same components. The principle of the present disclosure is implemented in a suitable computing environment for illustrative purposes. The following description is based on the various illustrated embodiments of the present disclosure, which should not be construed as limitations to other various embodiments of the present disclosure not detailed herein.

In the following description, the various embodiments of the present disclosure will be described with reference to procedures and symbols of operations which are performed by one or more computers, unless otherwise described. Therefore, it will be understood that the following procedures and operations, which are performed by a computer, are manipulated by a computer processing unit representative of processing electronic signals of data of a structured type. The manipulation converts the data or maintains the data in a position in the memory of the computer, which reconfigures or otherwise changes operation of the computer in a manner known to a person skilled in the art. The data structure of the maintained data is at a physical location in the memory, which has properties defined by the data format. However, based upon the principle of the present disclosure described above, as it does not represent a limitation, a person skilled in the art will understand that the following procedures and operations may also be implemented in hardware.

As used herein, the terms “component”, “module”, “system”, “interface”, “process” and the like are generally intended to refer to the computer-related entities of hardware, a combination of hardware and software, software or the software in execution. For example, a component may be, but is not limited to, a process running on a processor, a processor, an object, an executable application, a thread of an execution, an application and/or a computer. By illustration, both the application running on a controller and the controller can be a component. One or more components may be in an executing process and/or thread, and the components may be located on one computer and/or distributed between two or more computers.

Moreover, the claimed subject matter may be implemented using standard programming and/or engineering techniques to produce software, firmware, hardware or any combination thereof to control a computer to implement a method, an apparatus or an article of manufacture of the disclosed subject matter. As used herein, the term “article of manufacture” is intended to encompass computer programs that can be accessed from any computer readable device, carrier or medium. A person skilled in the art will recognize that many modifications may be made to this configuration without departing from the scope of the claimed subject matter.

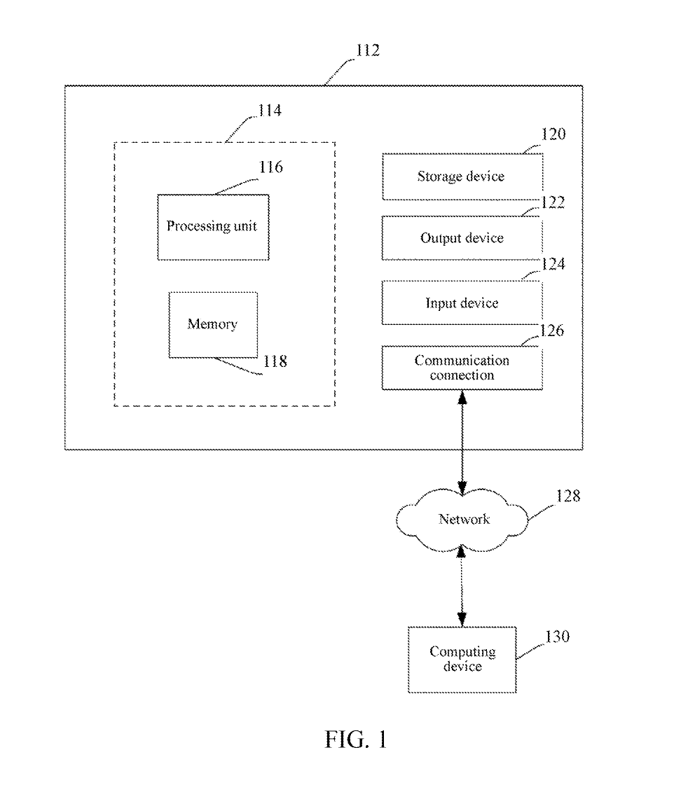

FIG. 1 and the ensuing discussion provide a working environment for a realization of the electronic device of the retrieval apparatus based on a browser according to the present disclosure with a brief and general description. The working environment in FIG. 1 is merely one example of a suitable working environment, and is not intended to suggest any limitation to the scope of the working environment with use or functionality. An example of the electronic device 112 includes, but is not limited to, a personal computer, a server computer, a handheld or laptop device, a mobile device (such as mobile phone, personal digital assistant (PDA), media player, etc.), a multiprocessor system, a consumer electronic device, a minicomputer, a mainframe computer, a distributed computing environment including any of the above systems or devices, and so on.

Although not essential, the term “computer readable instructions” is described in a universal background executed by one or more electronic devices. Computer readable instructions may be distributed via a computer readable medium (discussed below). The computer readable instructions may be implemented as program modules, such as functions, objects, application programming interfaces (APIs) and data structures that perform particular tasks or implement particular abstract data types. Typically, the functions of the computer readable instructions can be arbitrarily combined or distributed in various environments.

FIG. 1 illustrates an example of the electronic device 112 including various embodiments of a retrieval apparatus based on a browser according to the present disclosure. In one configuration, the electronic device 112 includes at least one processing unit 116 and a memory 118. According to the exact configuration and type of the electronic device, the memory 118 may be a volatile memory (such as a RAM), a nonvolatile memory (such as a ROM or a flash memory), or a combination of both. The configuration is shown by dotted lines 114 in FIG. 1.

In various embodiments, the electronic device 112 may include additional characteristics and/or functions. For example, the device 112 may include an additional storage device (such as a removable storage device and/or a non-removable storage device), which includes, but is not limited to, a magnetic storage device, an optical storage device or the like. The additional storage device is shown by a storage device 120 in FIG. 1. In various embodiments, computer readable instructions configured to implement various embodiments provided herein may be stored in the storage device 120. The storage device 120 may also store other computer readable instructions configured to implement an operating system, an application, and so on. The computer readable instructions may be uploaded in the memory 118, and be executed by, for example, the processing unit 116.

The term “computer readable medium” used herein includes a computer storage medium. The computer storage medium includes volatile, nonvolatile, removable, non-removable mediums implemented with any method or technique configured to store information, such as computer readable instructions or other data. The memory 118 and the storage device 120 are examples of the computer storage medium. The computer storage medium includes, but is not limited to, a RAM, a ROM, an EEPROM, a flash memory or other memory technologies, a CD-ROM, a digital versatile disk (DVD) or other optical storage devices, a cassette tape, a tape, a disk storage device or other magnetic storage devices, or any other medium which can be configured to store expected information and can be accessed by the electronic device 112. Any kinds of such computer storage mediums may be a part of the electronic device 112.

The electronic device 112 may further include a communication connection 126 which permits the electronic device 112 to communicate with other devices. The communication connection 126 may include, but is not limited to, a modem, a network interface card (NIC), an integrated network interface, an RF transmitter/receiver, an infrared port, a USB connected to or configured to connect the electronic device 112 to another interface of another electronic device. The communication connection 126 may include a cable connection or a wireless connection. The communication connection 126 may transmit and/or receive communication mediums.

The term “computer readable medium” may include a communication medium. The communication medium typically includes computer readable instructions or other data, such as in a carrier wave or other transport mechanisms with “modulated data signals”, and includes any information delivery medium. The term “modulated data signal” may include a signal that one or more signal characteristics will be set or changed by the way that information is coded into the signals.

The electronic device 112 may include an input device 124, such as a keyboard, a mouse, a pen, a voice input device, a touch input device, an infrared camera, a video input device and/or any other input devices. The device 112 may also include an output device 122, such as one or more monitors, a loudspeaker, a printer and/or any other output devices. The input device 124 and the output device 122 may be connected to the electronic device 112 via a cable connection, a wireless connection or any combination thereof. In various embodiments, an input device or output device from another electronic device may be used as the input device 124 or the output device 122 of the electronic device 112.

Components of the electronic device 112 may be connected through a variety of interconnections (such as bus connections). Such interconnections may include a peripheral component interconnect (PCI) (e.g., fast PCI), a universal serial bus (USB), a FireWire (IEEE 1394), an optical bus structure, etc. In various embodiments, the components of the electronic device 112 may be interconnected via a network. For example, the memory 118 may be constituted by multiple physical memory units located in different physical locations and interconnected through the network.

A person skilled in the art will realize that a storage device configured to store computer readable instructions may be distributed across a network. For example, the electronic device 130, which is accessible via the network 128, may store computer readable instructions configured to implement various embodiments provided in the present disclosure. The electronic device 112 may access the electronic device 130 and download a part of or all the computer readable instructions for execution. Alternatively, the electronic device 112 may download a plurality of computer readable instructions as necessary. It is also possible that some instructions are executed in the electronic device 112 and some instructions are executed in the electronic device 130.

Operations of the various embodiments are described herein. In one various embodiment, the one or more operations may constitute one or more computer readable instructions stored in a computer readable medium, which will enable the computing device to perform the operation after being executed by the electronic device. Part or all of the described operation sequence should not be construed to imply that these operations are sequentially related. A person skilled in the art will appreciate that alternative sorts have the benefit of the specification. Moreover, it should be understood that not all operations must be present in the various embodiments provided herein.

The word “preferred” used herein means, for instance, example or illustrations. Herein, all the “preferred” in any aspect or design is not necessarily to be construed as advantageous over other aspects or designs. On the contrary, the word “preferred” shows the concept in a certain manner. As used herein, the term “or” is intended to mean containing “or” not exclude “or”. That is, unless otherwise specified or clear from the context, “X employs A or B” means naturally including any arrangement thereof. That is, if X employs A; X employs B; or X employs both A and B, then “X employs A or B” is met in any of the foregoing examples.

Although the present disclosure has been illustrated and described with respect to one or more implementations, a person skilled in the art will think of equivalent variants and modifications based on reading and understanding the specification and drawings. The present disclosure includes all kinds of equivalent variants and modifications and is merely limited by the scope of the appended claims. In particular, regarding the various functions performed by the components (such as elements or resources), the terms used to describe such components are intended to correspond to any component (unless otherwise indicated) which performs the specified function of the components (for example, they are functionally equivalent), even if not structurally equivalent to the disclosed structure which performs the functions in the exemplary implementations of the present disclosure shown herein. In addition, while a particular feature of the present disclosure has been disclosed with respect to one of several implementations, such a feature may be combined with one or more other features of the other implementations as may be described and advantageous for any given or particular application. Further, the terms “include”, “have”, “with” or variants thereof are used in the detailed description or the claims and such terms are intended to be inclusive in a manner similar to the term “comprise”.

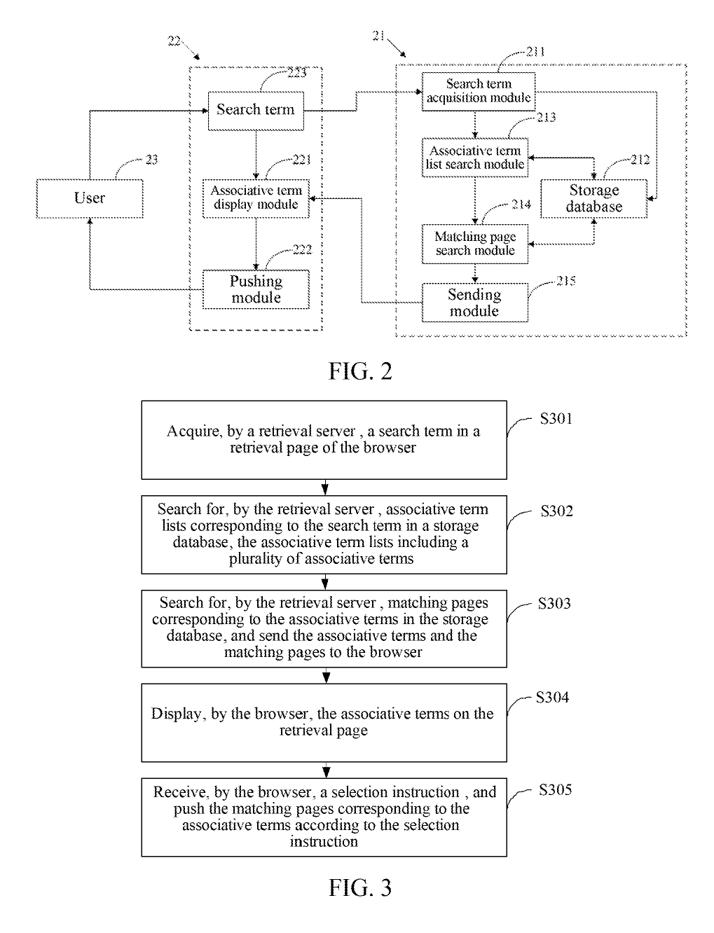

FIG. 2 is a block diagram of one various embodiment of the retrieval apparatus based on a browser according to the present disclosure. Components in the retrieval apparatus based on a browser of the various embodiments may be disposed in the electronic device 112, and the retrieval apparatus includes a retrieval server 21 and a browser 22. The retrieval server 21 is located at the cloud, the browser 22 is located at a client, and thus the retrieval server 21 in the retrieval apparatus of the various embodiments may achieve fast retrieval feedback, thereby improving retrieval efficiency of the browser 22.

The retrieval server 21 includes a search term acquisition module 211, a storage database 212, an associative term list search module 213, a matching page search module 214, and a sending module 215. The search term acquisition module 211 is configured to acquire a search term 223 on a retrieval page of the browser 22. The storage database 212 is configured to store associative term lists related to the search term 223 and matching pages corresponding to associative terms. The associative term list search module 213 is configured to search for associative term lists corresponding to the search term 223 in the storage database 212, the associative term lists including a plurality of associative terms. The matching page search module 214 is configured to search for matching pages corresponding to the associative terms in the storage database 212. The sending module 215 is configured to send the associative terms and the matching pages to the browser 22. The search term 223 is a term input by a user 23 on a retrieval page of the browser 22. The associative terms are words and phrases that can be associated through the search term 223, one search term 223 may correspond to a plurality of associative terms, for example, if the user 23 inputs a search term 223 “Dad” in a search box of the retrieval page, associative terms “Where are we going Dad”, “Where are we going Dad Hunan TV” and “Where are we going Dad, Season 2” may be generated, all the associative terms corresponding to one search term 223 may make up an associative term list, and the same search term 223 may correspond to different associative terms in different times (corresponding associative term lists may be generated according to retrieval rates in different times). The matching pages are pages associated with corresponding associative terms, matching pages are generally determined according to access rates of the associative terms, if an associative term is “Where are we going Dad”, the matching page may be an official website where video of “Where are we going Dad” can be played, and the same associative term may correspond to different associative terms in different times (corresponding matching pages may be generated according to retrieval rates in different times).

The browser 22 includes an associative term display module 221 and a pushing module 222. The associative term display module 221 is configured to display the associative terms on the retrieval page; and the pushing module 222 is configured to receive a selection instruction, and push the matching pages corresponding to the associative terms according to the selection instruction.

In use of the retrieval apparatus based on a browser of the various embodiments, at first, a user 23 inputs a search term 223 in a search box of a retrieval page of the browser 22, and the search term acquisition module 211 of the retrieval server 21 may acquire the search term 223, such as “Dad”.

Afterwards, the associative term list search module 213 of the retrieval server 21 searches for associative term lists corresponding to the search term 223 in the storage database 212, if the search term 223 is “Dad”, associative term lists corresponding to the search term 223 “Dad” can be acquired, and the associative term lists include a plurality of associative terms, for example, the associative terms “Where are we going Dad”, “Where are we going Dad Hunan TV”, “Where are we going Dad, Season 2” and the like.

Then, the matching page search module 214 of the retrieval server 21 searches for matching pages corresponding to all the associative terms in the storage database 212, herein, each associative term corresponds to one matching page. Different associative terms may correspond to the same matching page, and types of the matching pages may include, but are not limited to, fiction pages, video pages, web pages or software download pages. For example, the matching page corresponding to the associative term “Where are we going Dad” may be a video page where video of “Where are we going Dad” is played.

Finally, the sending module 215 of the retrieval server 21 sends the associative terms found in the associative term list search module 213 and the corresponding matching pages found in the matching page search module 214 to the browser 22. The associative terms may be arranged in size order of access rates. The associative term display module 221 of the browser 22 displays the corresponding associative terms in a drop-down list of the search box of the retrieval page of the browser 22, and the associative terms may be displayed on the retrieval page in size order of access rates. If the user clicks the associative terms (that is, the browser 22 receives a selection instruction of the user), the pushing module 222 of the browser 22 will push matching pages corresponding to the associative terms to the user 23 according to the selection instruction.

In this way, the retrieval process of the retrieval apparatus of the various embodiments is completed. The retrieval apparatus based on a browser of the various embodiments may directly acquire corresponding retrieval data from a storage database, thereby shortening retrieval time of the retrieval server and improving retrieval efficiency of users.

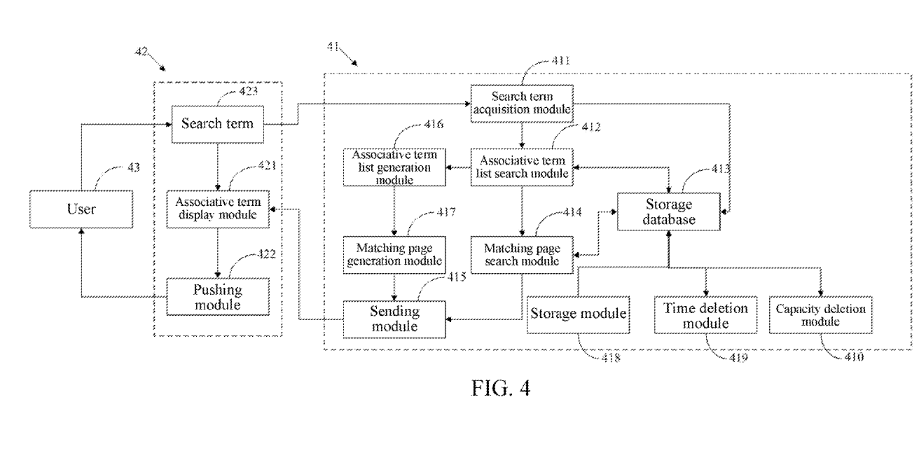

Referring to FIGS. 2 and 3, FIG. 3 is a flowchart of one various embodiment of a retrieval method based on a browser according to the present disclosure. The retrieval method based on a browser of the various embodiments may be implemented with the retrieval apparatus based on a browser, the method including the following.

Block 301: Acquiring, by a retrieval server, a search term on a retrieval page of the browser;

Block 302: Searching for, by the retrieval server, associative term lists corresponding to the search term in a storage database, the associative term lists including a plurality of associative terms;

Block 303: Searching for, by the retrieval server, matching pages corresponding to the associative terms in the storage database, and sending the associative terms and the matching pages to the browser;

Block 304: Displaying, by the browser, the associative terms on the retrieval page; and

Block 305: Receiving, by the browser, a selection instruction, and pushing the matching pages corresponding to the associative terms according to the selection instruction. The retrieval method of the various embodiments ends at block S305.

The procedure of each block of the retrieval method based on a browser of the various embodiments are described below in detail.

In block S301, a user 23 inputs a search term 223 in a search box of a retrieval page of the browser 22, and the search term acquisition module 211 of the retrieval server 21 may acquire the search term 223, such as “Dad”. Proceed to block S302.

In block S302, the associative term list search module 213 of the retrieval server 21 searches for associative term lists corresponding to the search term 223 in the storage database 212, if the search term 223 is “Dad”, associative term lists corresponding to the search term 223 “Dad” can be acquired, and the associative term lists may include a plurality of associative terms. For example, the associative terms “Where are we going Dad”, “Where are we going Dad Hunan TV”, “Where are we going Dad, Season 2” and the like. Proceed to block S303.

In block S303, the matching page search module 214 of the retrieval server 21 searches for matching pages corresponding to all the associative terms in the storage database 212, herein, each associative term corresponds to one matching page, but different associative terms may correspond to the same matching page, and types of the matching pages may include, but are not limited to, fiction pages, video pages, web pages or software download pages. For example, the matching page corresponding to the associative term “Where are we going Dad” may be a video page where video of “Where are we going Dad” is played. Then, the sending module 215 of the retrieval server 21 sends the associative terms found in the associative term list search module 213 and the corresponding matching pages found in the matching page search module 214 to the browser 22. The associative terms may be arranged in size order of access rates. Proceed to block S304.

In block S304, the associative term display module 221 of the browser 22 displays the corresponding associative terms in a drop-down list of the search box of the retrieval page of the browser 22 and the associative terms may be displayed on the retrieval page in size order of access rates. Proceed to block S305.

In block S305, if the user clicks the associative terms (that is, the browser 22 receives a selection instruction of the user), the pushing module 222 of the browser 22 will push matching pages corresponding to the associative terms to the user 23 according to the selection instruction.

In this way, the retrieval process of the retrieval method of the various embodiments is completed. The retrieval method based on a browser of the various embodiments may directly acquire corresponding retrieval data from a storage database, thereby shortening retrieval time of the retrieval server and improving retrieval efficiency of users.

FIG. 4 is a block diagram of one various embodiment of the retrieval apparatus based on a browser according to the present disclosure. Components in the retrieval apparatus based on a browser of the various embodiments may be disposed in the electronic device 112. The retrieval server 41 of the retrieval apparatus, on the basis of the various embodiments, further includes an associative term list generation module 416, a matching page generation module 417, a storage module 418, a time deletion module 419 and a capacity deletion module 410. The associative term list generation module 416 is configured to generate associative term lists corresponding to a search term 423 according to the search term. The matching page generation module 417 is configured to generate matching pages corresponding to associative terms in the associative term lists. The storage module 418 is configured to store the generated associative term lists and the matching pages corresponding to the associative terms in the associative term lists in the storage database 413. The time deletion module 419 is configured to delete associative term lists in the storage database 413 whose storage time is greater than set time and matching pages corresponding to associative terms in the associative term lists. The capacity deletion module 410 is configured to delete some associative term lists and matching pages corresponding to associative terms in the associative term lists until storage data in the storage database 413 is less than set capacity when the storage data in the storage database 413 is greater than the set capacity; wherein storage time of the associative term lists and the matching pages corresponding to the associative terms in the associative term lists which are deleted in the storage database is greater than storage time of associative term lists and matching pages corresponding to associative terms in the associative term lists which are not deleted in the storage database.

In use of the retrieval apparatus based on a browser of the various embodiments, first, a user 43 inputs a search term 423 in a search box of a retrieval page of the browser 42, and the search term acquisition module 411 of the retrieval server 41 may acquire the search term 423, such as “Dad”.

Afterwards, the associative term list search module 412 of the retrieval server 41 searches for associative term lists corresponding to the search term 423 in the storage database 413. If the search term 423 is “Dad”, associative term lists corresponding to the search term 423 “Dad” can be acquired, and the associative term lists may include a plurality of associative terms, for example, the associative terms “Where are we going Dad”, “Where are we going Dad Hunan TV”, “Where are we going Dad, Season 2” and the like.

If the associative term list search module 412 does not find associative term lists corresponding to the search term 423 in the storage database 413, the associative term list generation module 416 of the retrieval server 41 may generate associative term lists corresponding to the search term 423 according to the search term 423, and herein, the associative term lists may be generated locally at the retrieval server 41, or a request for a retrieval service may be sent to another server, to acquire corresponding associative term lists.

If the associative term list search module 412 finds associative term lists corresponding to the search term 423 in the storage database 413, the matching page search module 414 of the retrieval server 41 then searches for matching pages corresponding to all the associative terms in the storage database 413. Herein, each associative term corresponds to one matching page, but different associative terms may correspond to the same matching page, and types of the matching pages may include, but are not limited to, fiction pages, video pages, web pages or software download pages. For example, the matching page corresponding to the associative term “Where are we going Dad” may be a video page where video of “Where are we going Dad” is played.

The associative term list generation module 416 generates associative term lists corresponding to the search term 423 according to the search term 423, and the matching page generation module 417 of the retrieval server 41 generates matching pages corresponding to associative terms in the associative term lists. Herein, the matching pages may be generated locally at the retrieval server 41, or a request for a retrieval service may be sent to another server (for example, a resource server), to acquire corresponding matching pages.

If a request for a retrieval service is sent to a resource server, the generation process of the matching pages may be as follows. The matching page generation module 417 sends the associative terms to the resource server. The resource server determines matching pages corresponding to the associative terms according to retrieval data of the associative terms (such as retrieve users' click rates of websites of retrieval results of the associative terms), the matching pages may be a page with the highest user click rate, and the matching page is returned to the retrieval server 41. The matching page generation module 417 of the retrieval server 41 receives the matching pages returned by the resource server.

The sending module of the retrieval server 41 sends the associative terms found in the associative term list search module 412 and the corresponding matching pages found in the matching page search module 414 to the browser 42, or sends the associative terms generated by the associative term list generation module 416 and the corresponding matching pages generated in the matching page generation module 417 to the browser 42. The associative terms may be arranged in size order of access rates. The associative term display module 421 of the browser 42 displays the corresponding associative terms in a drop-down list of the search box of the retrieval page of the browser 42 and the associative terms may be displayed on the retrieval page in size order of access rates. If the user clicks the associative terms (that is, the browser 42 receives a selection instruction of the user), the pushing module 422 of the browser 42 will push matching pages corresponding to the associative terms to the user 43 according to the selection instruction.

If the retrieval server 41 does not find matching pages corresponding to the associative terms in the storage database 413 and the matching page generation module 414 does not generate matching pages corresponding to the associative terms either, the sending module 415 sends the associative terms as well as the search results and generation results to the browser 42. The associative terms may be arranged in size order of access rates. The associative term display module 421 of the browser 42 displays the corresponding associative terms in a drop-down list of the search box of the retrieval page of the browser 42 and the associative terms may be displayed on the retrieval page in size order of access rates. If the user clicks the associative terms (that is, the browser 42 receives a selection instruction of the user 43), the pushing module 422 of the browser 42 will push retrieval pages corresponding to the associative terms to the user 43 according to the selection instruction.

The retrieval apparatus based on a browser of the various embodiments further includes a storage module 418, and in order to further improve retrieval efficiency of the retrieval apparatus, the storage module 418 may store the associative terms generated by the associative term list generation module 416 and the corresponding matching pages generated in the matching page generation module 417 in the storage database 413. As popular search terms change in real-time, the storage module 418 in the various embodiments may implement and adjust retrieval data in the storage database 413 according to search terms of the user, which can further improve subsequent retrieval efficiency of the same search term.

The retrieval apparatus based on a browser of the various embodiments further includes a time deletion module 419, and in order to further improve retrieval efficiency of the retrieval apparatus, the time deletion module 419 deletes associative term lists in the storage database 413 whose storage time is greater than set time and matching pages corresponding to associative terms in the associative term lists. In this way, the time deletion module 419 can timely delete some unpopular search terms from the storage database 413, which also improves retrieval efficiency of the retrieval apparatus.

The retrieval apparatus based on a browser of the various embodiments further includes a capacity deletion module 410, and in order to further improve retrieval efficiency of the retrieval apparatus, the capacity deletion module 410 deletes an associative term list with the earliest storage time and matching pages corresponding to associative terms in the associative term list until storage data in the storage database 413 is less than set capacity when the storage data in the storage database 413 is greater than the set capacity. In this way, the current most popular search term 423 remains in the storage database 413, which also improves retrieval efficiency of the retrieval apparatus.

The matching pages in the storage database include types of the matching pages, and when the associative term display module 421 of the browser 42 displays corresponding associative terms on the retrieval page of the browser 42, types of the matching pages corresponding to the associative terms may also be displayed on the retrieval page at the same time, such as narratives, video, websites or software. Herein, the types of the matching pages may be displayed through texts or displayed through icons. In this way, the user can understand the type of the matching pages more clearly, which further enhances the success rate of pushing of retrieval results.

The retrieval process of the retrieval apparatus of the various embodiments is completed. The retrieval apparatus based on a browser of the various embodiments, on the basis of the various embodiments, further improves the success rate of retrieval and retrieval efficiency by setting an associative term list generation module, a matching page generation module, a storage module, a time deletion module, and a capacity deletion module.

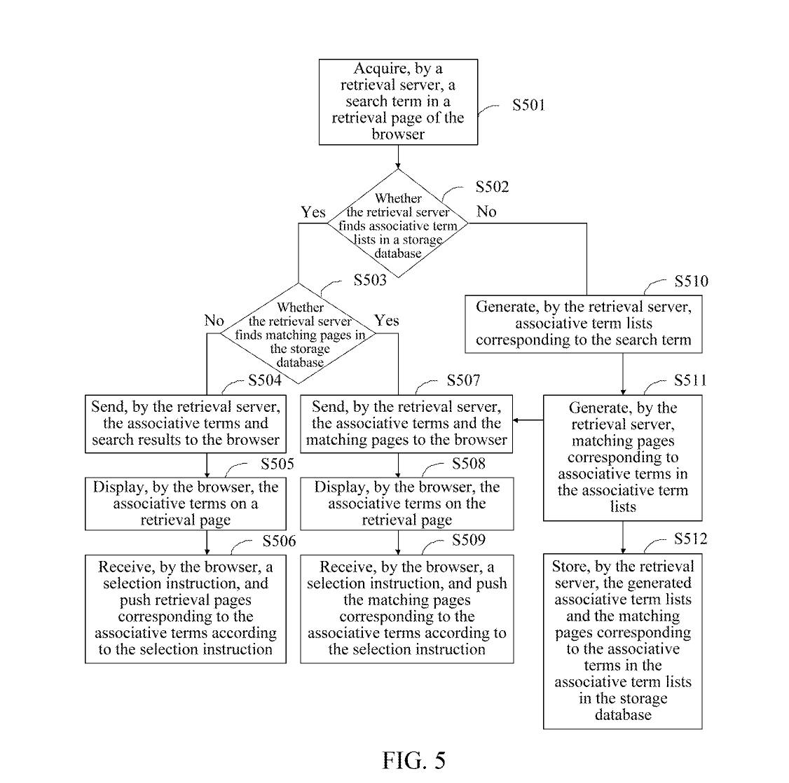

Referring to FIGS. 4 and 5, FIG. 5 is a flowchart of one various embodiment of the retrieval method based on a browser according to the present disclosure. The retrieval method based on a browser of the various embodiments may be implemented with the above retrieval apparatus based on a browser, the method including the following.

Block S501: Acquiring, by a retrieval server, a search term on a retrieval page of the browser;

Block S502: Judging whether the retrieval server finds associative term lists in a storage database. If the retrieval server finds associative term lists in the storage database, proceeding to block S503. If the retrieval server does not find associative term lists in the storage database, proceeding to block S510;

Block S503: Judging whether the retrieval server finds matching pages in the storage database. If the retrieval server does not find matching pages in the storage database, proceeding to block S504. If the retrieval server finds matching pages in the storage database, proceeding to block S507;

Block S504: Sending, by the retrieval server, the associative terms and search results to the browser;

Block S505: Displaying, by the browser, the associative terms on a retrieval page;

Block S506: Receiving, by the browser, a selection instruction, and pushing retrieval pages corresponding to the associative terms according to the selection instruction;

Block S507: Sending, by the retrieval server, the associative terms and the matching pages to the browser;

Block S508: Displaying, by the browser, the associative terms on the retrieval page;

Block S509: Receiving, by the browser, a selection instruction, and pushing the matching pages corresponding to the associative terms according to the selection instruction;

Block S510: Generating, by the retrieval server, associative term lists corresponding to the search term;

Block S511: Generating, by the retrieval server, matching pages corresponding to associative terms in the associative term lists; then proceeding to block S507 and block S512; and

Block S512: Storing, by the retrieval server, the generated associative term lists and the matching pages corresponding to the associative terms in the associative term lists in the storage database.

The retrieval method of the various embodiments ends at block S506, block S509 and block S512.

Each block of the retrieval method based on a browser of the various embodiments are described below in detail.

In block S501, a user 43 inputs a search term 423 in a search box of a retrieval page of the browser 42, and the search term acquisition module 411 of the retrieval server 41 may acquire the search term 423, such as “Dad”. Proceed to block S502.

In block S502, the associative term list search module 412 of the retrieval server 41 searches for associative term lists corresponding to the search term 423 in the storage database 413. If the search term 423 is “Dad”, associative term lists corresponding to the search term 423 “Dad” can be acquired. The associative term lists may include a plurality of associative terms, for example, the associative terms “Where are we going Dad”, “Where are we going Dad Hunan TV”, “Where are we going Dad, Season 2” and the like.

If the associative term list search module 412 finds associative term lists in the storage database 413, proceed to block S503. If the associative term list search module 412 does not find associative term lists in the storage database 413, proceed to block S510.

In block S503, the associative term list search module 412 searches for associative term lists corresponding to the search term 423 in the storage database 413, and the matching page search module 414 of the retrieval server 41 searches for matching pages corresponding to all the associative terms in the storage database 413. Herein, each associative term corresponds to one matching page, but different associative terms may correspond to the same matching page. Different types of the matching pages may include, but are not limited to, narratives, video pages, web pages or software download pages. For example, the matching page corresponding to the associative term “Where are we going Dad” may be a video page where video of “Where are we going Dad” is played.

If the matching page search module 414 does not find matching pages in the storage database 413, proceed to block S504. If the matching page search module 414 finds matching pages in the storage database 413, proceed to block S507.

In block S504, if the matching page search module 414 does not find matching pages in the storage database 413, the sending module 415 of the retrieval server 41 sends the associative terms and search results to the browser 42 and the associative terms may be arranged in size order of access rates. Proceed to block S505.

In block S505, the associative term display module 421 of the browser 42 displays the corresponding associative terms in a drop-down list of the search box of the retrieval page of the browser 42 and the associative terms may be displayed on the retrieval page in size order of access rates. Proceed to block S506.

In block S506, if the user clicks the associative terms (that is, the browser 42 receives a selection instruction of the user 43), the pushing module 422 of the browser 42 will push retrieval pages corresponding to the associative terms to the user 43 according to the selection instruction.

In block S507, if the matching page search module 414 finds matching pages in the storage database 413, the sending module 415 of the retrieval server 41 sends the associative terms found in the associative term list search module 412 and the corresponding matching pages found in the matching page search module 414 to the browser 42, or if the matching page generation module 417 generates matching pages corresponding to the associative terms, the sending module 415 of the retrieval server 41 sends the associative terms generated by the associative term list generation module 416 and the corresponding matching pages generated in the matching page generation module 417 to the browser 42. The associative terms may be arranged in size order of access rates. Proceed to block S508.

In block S508, the associative term display module 421 of the browser 42 displays the corresponding associative terms in a drop-down list of the search box of the retrieval page of the browser 42 and the associative terms may be displayed on the retrieval page in size order of access rates. Proceed to block S509.

In block S509, if the user clicks the associative terms (that is, the browser 42 receives a selection instruction of the user), the pushing module 422 of the browser 42 will push matching pages corresponding to the associative terms to the user 43 according to the selection instruction.

In block S510, if the associative term list search module 412 does not find associative term lists corresponding to the search term 423 in the storage database, the associative term list search module 412 of the retrieval server 41 may generate associative term lists corresponding to the search term 423 according to the search term 423. Herein, the associative term lists may be generated locally at the retrieval server 41, or a request for a retrieval service may be sent to another server, to acquire corresponding associative term lists. Proceed to block S511.

In block S511, the matching page generation module 417 of the retrieval server 41 generates matching pages corresponding to associative terms in the associative term lists. Herein, the matching pages may be generated locally at the retrieval server 41, or a request for a retrieval service may be sent to another server (for example, a resource server), to acquire corresponding matching pages.

If a request for a retrieval service is sent to a resource server, the generation process of the matching pages may be as follows. The matching page generation module 417 sends the associative terms to the resource server. The resource server determines matching pages corresponding to the associative terms according to retrieval data of the associative terms (such as retrieve users' click rates of websites of retrieval results of the associative terms), the matching pages may be a page with the highest user click rate, and the matching page is returned to the retrieval server 41. The matching page generation module 417 of the retrieval server 41 receives the matching pages returned by the resource server. If the matching page generation module 414 does not generate matching pages corresponding to the associative terms, the sending module 415 of the retrieval server 41 may send the associative terms and the generation results to the browser 42. Proceed to block S507 and block S512.

In block S512, in order to further improve retrieval efficiency of the retrieval apparatus, the storage module 418 of the retrieval server 41 may store the associative terms generated by the associative term list generation module 416 and the corresponding matching pages generated in the matching page generation module 417 in the storage database 413. As popular search terms change in real-time, the storage module 418 in the various embodiments may implement and adjust retrieval data in the storage database 413 according to search terms of the user, which can further improve subsequent retrieval efficiency of the same search term.

In this way, the retrieval process of the retrieval method of the various embodiments is completed.

In the retrieval method based on a browser of the various embodiments, the time deletion module 419 of the retrieval server 41 deletes associative term lists in the storage database 413 whose storage time is greater than set time and matching pages corresponding to associative terms in the associative term lists. In this way, the time deletion module 419 can timely delete some unpopular search terms from the storage database 413, which also improves retrieval efficiency of the retrieval apparatus.

In the retrieval method based on a browser of the various embodiments, the capacity deletion module 410 of the retrieval server 41 deletes an associative term list with the earliest storage time and matching pages corresponding to associative terms in the associative term list until storage data in the storage database 413 is less than set capacity when the storage data in the storage database 413 is greater than the set capacity. In this way, the current most popular search term 423 remains in the storage database 413, which also improves retrieval efficiency of the retrieval apparatus.

In the retrieval method based on a browser of the various embodiments, the matching pages in the storage database 413 include types of the matching pages, and when the associative term display module 421 of the browser 42 displays corresponding associative terms on the retrieval page of the browser 42, types of the matching pages corresponding to the associative terms may also be displayed on the retrieval page at the same time, such as narratives, video, websites or software. Herein, the types of the matching pages may be displayed through texts or displayed through icons. In this way, the user can understand the type of the matching pages more clearly, which further enhances the success rate of pushing of retrieval results.

The retrieval method based on a browser of the various embodiments, on the basis of the various embodiments, further improves the success rate of retrieval and retrieval efficiency by setting an associative term list generation module, a matching page generation module, a storage module, a time deletion module and a capacity deletion module.

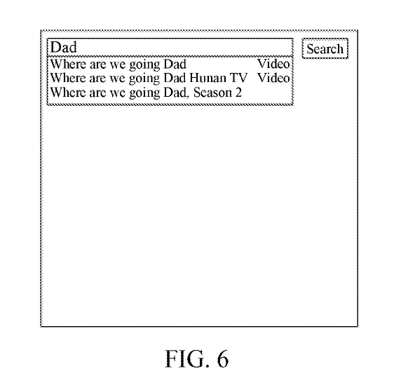

The procedures of the retrieval method and the retrieval apparatus based on a browser of the present disclosure are described below in detail through FIG. 6. FIG. 6 depicts a page of a browser according to the present disclosure. FIG. 6 is a diagram of a browser retrieval page of the retrieval apparatus based on a browser.

If a user inputs a search term “Dad” in a search box of the retrieval page of FIG. 6, a retrieval server receives the search term, and generates corresponding associative terms according to the search term and matching pages corresponding to the associative terms. Associative terms of the search term “Dad” are “Where are we going Dad”, “Where are we going Dad Hunan TV” and “Where are we going Dad, Season 2”, and the three associative terms constitute an associative term list corresponding the search term. The associative term “Where are we going Dad” corresponds to a matching page of a video type, the associative term “Where are we going Dad Hunan TV” corresponds to a matching page of a video type, but no corresponding matching page has been found for the associative term “Where are we going Dad, Season 2”.

The retrieval server sends the generated associative terms and matching pages corresponding to the associative terms to the browser, the browser displays the associative terms (which may be sorted according to retrieval rates) in a drop-down list of the search box, and displays the types of the matching pages corresponding to the associative terms on the right of the associative terms, and if the associative terms have no corresponding matching pages, no texts or icons are displayed on the right of the associative terms.

When a user clicks an associative term on the retrieval page, the browser will push a matching page corresponding to the associative term to the user. If the user clicks the associative term “Where are we going Dad”, the matching page of the video type corresponding to the associative term “Where are we going Dad” is pushed to the user. If the user clicks the associative term “Where are we going Dad, Season 2”, as the associative term has no corresponding matching page, the browser directly pushes a retrieval page of the associative term “Where are we going Dad, Season 2” to the user.

The retrieval method and the retrieval apparatus based on a browser in the present disclosure directly search for associative term lists corresponding to a search term in a storage database and search for matching pages corresponding to associative terms in the storage database, display the associative terms on a retrieval page, and directly push matching pages for user access when a user clicks the associative terms, thereby shortening retrieval time of the retrieval server, improving retrieval efficiency of users; and solving the technical issues of low retrieval feedback speed and retrieval efficiency in the retrieval method and the retrieval apparatus of the existing technology.

Functional units in the embodiments of the present disclosure may be integrated into one processing module, each unit may exist separately, or two or more units may be integrated into one module. The integrated module may be implemented in a form of hardware, or implemented with a form of a software functional module. If the integrated module is implemented in the form of a software functional module, the integrated module may also be stored in a computer readable storage medium. The storage medium may be a read-only memory, a magnetic disk, an optical disc, or the like. The apparatuses or systems can perform the methods in the corresponding method embodiments.

Although the present disclosure has been disclosed above with various embodiments, the various embodiments are not intended to limit the present disclosure. A person of ordinary skill in the art can make various variations and modifications without departing from the scope of the present disclosure; therefore, the protection scope of the present disclosure is subject to the scope defined by the claims.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more procedures within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. §112(f) unless an element is expressly recited using the phrase “means for,” or in the case of a method claim using the phrases “operation for” or “step for.”

What is claimed is:

1. A retrieval method based on a browser, comprising:
acquiring, by a retrieval server, a search term on a retrieval page of the browser;
searching for, by the retrieval server, associative term lists corresponding to the search term in a storage database, the associative term lists comprising a plurality of associative terms;
searching for, by the retrieval server, matching pages corresponding to the associative terms in the storage database, and sending the associative terms and the matching pages to the browser;
displaying, by the browser, the associative terms on the retrieval page; and
receiving, by the browser, a selection instruction, and pushing the matching pages corresponding to the associative terms according to the selection instruction.

2. The retrieval method based on a browser according to claim 1, wherein the retrieval method comprises:
generating, by the retrieval server, associative term lists corresponding to the search term according to the search term if the retrieval server does not find associative term lists corresponding to the search term in the storage database; and
generating, by the retrieval server, matching pages corresponding to associative terms in the associative term lists.

3. The retrieval method based on a browser according to claim 2, wherein the generating, by the retrieval server, matching pages corresponding to associative terms in the associative term lists comprises:
sending, by the retrieval server, the associative terms to a resource server; and
determining, by the resource server, matching pages corresponding to the associative terms according to retrieval data of the associative terms, and returning the matching pages to the retrieval server.

4. The retrieval method based on a browser according to claim 2, wherein the retrieval method further comprises:
storing, by the retrieval server, the generated associative term lists and the matching pages corresponding to the associative terms in the associative term lists in the storage database.

5. The retrieval method based on a browser according to claim 4, wherein the retrieval method further comprises:
deleting, by the retrieval server, associative term lists in the storage database whose storage time is greater than set time and matching pages corresponding to associative terms in the associative term lists.

6. The retrieval method based on a browser according to claim 4, wherein the retrieval method further comprises:
deleting, by the retrieval server, some associative term lists and matching pages corresponding to associative terms in the associative term lists until storage data in the storage database is less than set capacity when the storage data in the storage database is greater than the set capacity;
wherein storage time of the associative term lists and the matching pages corresponding to the associative terms in the associative term lists which are deleted in the storage database is greater than storage time of associative term lists and matching pages corresponding to associative terms in the associative term lists which are not deleted in the storage database.

7. The retrieval method based on a browser according to claim 1, wherein the retrieval method comprises:
if the retrieval server does not find matching pages corresponding to the associative terms in the storage database;
receiving, by the browser, the selection instruction and pushing retrieval pages corresponding to the associative terms according to the selection instruction.

8. The retrieval method based on a browser according to claim 1, wherein the browser displays the associative terms on the retrieval page in size order of access rates.

9. The retrieval method based on a browser according to claim 1, wherein the matching pages in the storage database comprise types of the matching pages, the browser displays types of the matching pages corresponding to the associative terms on the retrieval page, and the types of the matching pages comprise fictions, video, websites or software.

10. A retrieval apparatus based on a browser, comprising:
a retrieval server, comprising:
a search term acquisition module, configured to acquire a search term on a retrieval page of the browser;
a storage database;
an associative term list search module, configured to search for associative term lists corresponding to the search term in the storage database, the associative term lists comprising a plurality of associative terms;
a matching page search module, configured to search for matching pages corresponding to the associative terms in the storage database; and
a sending module, configured to send the associative terms and the matching pages to the browser; and
the browser, comprising:
an associative term display module, configured to display the associative terms on the retrieval page; and
a pushing module, configured to receive a selection instruction, and push the matching pages corresponding to the associative terms according to the selection instruction.

11. The retrieval apparatus based on a browser according to claim 10, wherein the retrieval server further comprises:
an associative term list generation module, configured to generate associative term lists corresponding to the search term according to the search term; and
a matching page generation module, configured to generate matching pages corresponding to associative terms in the associative term lists.

12. The retrieval apparatus based on a browser according to claim 11, wherein
the matching page generation module is configured to send the associative terms to a resource server; and receive matching pages corresponding to the associative terms returned by the resource server;
wherein the resource server determines matching pages corresponding to the associative terms according to retrieval data of the associative terms.

13. The retrieval apparatus based on a browser according to claim 11, wherein the retrieval server further comprises:
a storage module, configured to store the generated associative term lists and the matching pages corresponding to the associative terms in the associative term lists in the storage database.

14. The retrieval apparatus based on a browser according to claim 13, wherein the retrieval server further comprises:
a time deletion module, configured to delete associative term lists in the storage database whose storage time is greater than set time and matching pages corresponding to associative terms in the associative term lists.

15. The retrieval apparatus based on a browser according to claim 13, wherein the retrieval server further comprises:
a capacity deletion module, configured to delete some associative term lists and matching pages corresponding to associative terms in the associative term lists until storage data in the storage database is less than set capacity when the storage data in the storage database is greater than the set capacity;
wherein storage time of the associative term lists and the matching pages corresponding to the associative terms in the associative term lists which are deleted in the storage database is greater than storage time of associative term lists and matching pages corresponding to associative terms in the associative term lists which are not deleted in the storage database.

16. The retrieval apparatus based on a browser according to claim 10, wherein the pushing module is configured to:
if the matching page search module does not find matching pages corresponding to the associative terms in the storage database;
the pushing module receives the selection instruction and push retrieval pages corresponding to the associative terms according to the selection instruction.

17. The retrieval apparatus based on a browser according to claim 10, wherein the browser displays the associative terms on the retrieval page in size order of access rates.

18. The retrieval apparatus based on a browser according to claim 10, wherein the matching pages in the storage database comprise types of the matching pages, the browser displays types of the matching pages corresponding to the associative terms on the retrieval page, and the types of the matching pages comprise fictions, video, websites or software.
